(19) United States
(12) Patent Application Publication
(10) Pub. No.: US 2015/0331250 A1
(43) Pub. Date: Nov. 19, 2015

(54) SHAKING CORRECTION DEVICE

(71) Applicants: Huizhou Dayawan Ever Bright Electronic Industry Co., Ltd., Huizhou (CN); JSS Optical Technology Co., Ltd., Hong Kong (HK); Huizhou Daya Bay Jss Optical Technology. Co., Ltd., Huizhou (CN)

(72) Inventor: Kokichi Terajima, Tokyo (JP)

(21) Appl. No.: 14/673,942

(22) Filed: Mar. 31, 2015

(30) Foreign Application Priority Data
May 15, 2014 (JP) 2014-101621

(51) Int. Cl. G02B 27/64

(52) U.S. Cl. CPC G02B 27/646

(57) ABSTRACT

The present invention provides a shaking correction device which can enable an automatic focusing unit to be difficult to rotate in a swinging direction and around an axis perpendicular to Z axis during swinging, enables an optical axis of a lens to be stable, and buffer components are easily arranged to the shaking correction device. The shaking correction device is such configured that the ends of the back sides of suspension wires are connected onto the extension ends of the elastic arms which are connected with the end parts of base frames arranged on a base plate and extend towards the center of the automatic focusing unit, and the ends of the front sides of the suspension wires are connected with flange parts arranged in the front of a magnet support.

### BACKGROUND OF THE INVENTION

1. Field of the Invention

The present invention relates to a shaking correction device for correcting shaking generated by a camera for a mobile telephone.

2. Description of Related Art

The shaking correction device needs to restrict shaking generated on a lens retained on an automatic focusing unit, and enables the lens or a lens support for retaining the lens to swing in a direction forming a right angle with an optical axis of the lens so as to restrict an image generated on an image sensor from shaking or shafting.

For example, a shaking correction device disclosed in a patent document 1 (JP Patent 2013-44924) includes a swinging unit, which supports a automatic focusing unit to be capable of swinging in a direction forming a right angle with the optical axis in a suspension mode by utilizing a plurality of suspension wires extending along the direction of the optical axis. And an electromagnetic driving mechanism including a coil for swinging and a plurality of permanent magnets is utilized, so that the lens swings together with the automatic focusing unit. The shaking correction device can prevent an image imaged on an image sensor from becoming fuzzy.

FIG. 6A is a perspective view of the shaking correction device 30 in the patent document 1, and FIG. 6B is an exploded view of the shaking correction device 30. In FIG. 6A and FIG. 6B, a direction of an optical axis of an unshown lens is taken as Z direction, and two directions forming right angles with the Z axis are taken as X (X axis) direction and Y (Y axis) direction.

As shown in FIG. 6A and FIG. 6B, the shaking correction device 30 includes an automatic focusing unit 41 and a swinging unit 42.

The automatic focusing unit 41 includes: a cylindrical lens support 38 for retaining the unshown lens; a coil 40 for automatic focusing wound on the outer circumference side of the lens support 38; four plate-shaped permanent magnets 34, disposed around an axis parallel to the Z axis at 90-degree intervals, and arranged opposite to the coil 40 for automatic focusing at intervals along the radial direction, and magnetic pole faces of which are respectively facing to the X direction and the Y direction; a frame-shaped magnet support 33 retained inside the side face 33a of the frame-shaped magnet support 33; a front side spring component 37A and a back side spring component 37B.

The swinging unit 42 includes: a plate-shaped base plate 31 provided with an opening in the center and facing to the Z direction; four suspension wires extending along the Z direction; the magnet support 33; the permanent magnets 34; X side coils 35x for swinging and Y side coils 35y for swinging wound on the Z direction and arranged opposite to the side faces on the −Z side of the permanent magnets 34 at intervals and mounted on the +Z side of the base plate 31. Therefore, the magnet support 33 and the permanent magnets 34 are shared by the automatic focusing unit 41 and the swinging unit 42. Moreover, the automatic focusing unit 41 is supported on the +Z side of the base plate 31 in a suspension mode by the swinging unit 42.

End parts of the lens support 38 of the automatic focusing unit 41 in front of the Z axis direction and at the back of the Z axis direction are respectively connected with the front side spring component 37A and the back side spring component 37B. Specifically, the lens support 38 is respectively connected with the respective inner side retaining parts 37a of the front side spring component 37A and the back side spring component 37B, and the end parts of the magnet support 33 in front of the Z axis direction and at the back of the Z axis direction are respectively connected with the respective outer side retaining parts 37b of the front side spring component 37A and the back side spring component 37B. Moreover, the wrist parts 37c of the front side spring component 37A and the back side spring component 37B are taken as springs to take effect so as to support the lens support 38 to be capable of moving in the Z direction in a suspension mode. Moreover, the front side spring component 37A comprises a plurality of L-shaped beam parts 37d extending from the periphery of the outer side retaining part 37b towards four corners.

The lens support 38 supported by the front side spring component 37A and the back side spring component 37B in a suspension mode is taken as the automatic focusing unit 41 to take effect. Therefore, along with the electrification of the coil 40 for automatic focusing, the lens support 38 can move in the Z axis direction.

The four corners of the base plate 31 of the swinging unit 42 are respectively connected with one end of each suspension wire 32. The other end of each suspension wire 32 is connected with the front end (the crossed part of the L-shaped) of each beam part 37d arranged on the outer side retaining part 37b of the front side spring component 37A of the automatic focusing unit 41. As a result, the automatic focusing unit 41 is supported by the suspension wires 32 so as to be capable of swinging in the X direction and the Y direction.

As shown in FIG. 6B, the X side coils 35x for swinging are respectively disposed on the −X side and the +X side of the base plate 31. Moreover, the Y side coils 35y for swinging are respectively disposed on the −Y side and the +Y side of the base plate 31. As a result, along with the electrification of the X side coils 35x for swinging, the permanent magnets 34 (automatic focusing unit 41) are enabled to swing in the X direction. Along with the electrification of the Y side coils 35y for swinging, the permanent magnets 34 (automatic focusing unit 41) are enabled to swing in the Y direction.

In the shaking correction device 30 with this structure, even if acting force towards the direction (+Z direction) far away from the base plate 31 or acting force towards the direction (−Z direction) close to the base plate 31 is applied to the automatic focusing unit 41 due to falling impact, the L-shaped beam parts 37d can also be elastically bent and deformed towards the Z direction so as to reduce tension or compressing force applied to the suspension wires 32. As a result, the suspension wires 32 can be prevented from being broken. Therefore, the beam parts 37d take effect as a breaking restriction component for preventing the four suspension wires 32 from being broken.

Moreover, as shown in FIG. 6A, a buffer component 39 formed by silicone gel and the like is arranged in a gap between the base plate 31 and the magnet support 33. The buffer component 39 restrains the unnecessary resonance of the shaking correction device, and improves the endurance of the shaking correction device 30 for the impact such as falling together with the beam parts 37d.

However, the L-shaped beam parts 37d as shown in the patent document 1 protrude towards the outside of the magnet support 33 to form a part of the front side spring component 37A. Therefore, when the automatic focusing unit 41 swings in the X axis direction and the Y axis direction corresponding to shaking, the beam parts 37d are bent around a direction which has right angle with the swinging direction and Z axis respectively. As a result, the optical axis of the unshown lens is tilt along with the bending of the beam part 37d. Moreover, as the gap between the base plate 31 and the magnet support 33 is relatively small, the buffer component 39 is difficult to set (coat), and the problem that the working performance becomes less efficient exists.

### BRIEF SUMMARY OF THE INVENTION

In view of the existing problems, the present invention aims to provide a shaking correction device. The shaking correction can enable an automatic focusing unit to be difficult to rotate in the direction which has right angle with the swinging direction and Z axis respectively, and enables an optical axis of a lens to become stable, and buffer member is easily arranged on the shaking correction device.

A shaking correction device includes: an automatic focusing unit, which is used for retaining a lens taking the side of an object to be shot as the front of the Z axis direction and enabling the lens to move in the Z axis direction; and a swinging unit, which enables the automatic focusing unit to swing in a direction forming a right angle with the Z axis. The swinging unit includes: a base plate arranged at the back of the automatic focusing unit in the Z axis direction; a magnet support disposed on the outer circumference of the automatic focusing unit; a plurality of suspension wires which extend from the base plate to the front of the Z axis direction and are used for supporting the magnet support in a suspension mode; and a plurality of elastic beams each of which is provided with an extension end extending towards the automatic focusing unit, the extension ends being bent towards the Z axis direction. The elastic beams are mounted on one or both of the base plate and the magnet support, and the end parts of the suspension wires are connected with the extension ends of the elastic beams.

According to the shaking correction device in the present invention, the automatic focusing unit is difficult to rotate in the direction which has right angle with the swinging direction and Z axis respectively. Moreover, when the shaking correction device suffers from impact, the elastic beams can further be elastically deformed so as to prevent the suspension wires from being broken.

Moreover, as a preferable embodiment of the present invention, the shaking correction device further includes a plurality of buffer components for restraining the vibration of the shaking correction device, and the buffer components are arranged among the elastic beams, the suspension wires and the side faces of the magnet support.

Therefore, the shaking correction device of the present invention is such disposed that the setting positions of the buffer components are released towards the outside, and thus the work of disposing the buffer components is easy to implement, and the working performance can be improved.

Moreover, as a preferable embodiment of the present invention, a plurality of reinforcement frames for fixing the elastic beams on one or both of the base plate and the magnet support are mounted on the elastic beams.

Therefore, the shaking correction device of the present invention can improve the fixation strength of the elastic beams on the base plate. Moreover, the summary of the invention does not list all features required by the present invention, and auxiliary combination of these features can also become the present invention.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1A and FIG. 1B are perspective views of a shaking correction device in according to a first embodiment of the present invention;

FIG. 2 is an exploded view of the shaking correction device in according to the first embodiment;

FIG. 3 is a perspective view of another example of the shaking correction device in the first embodiment;

FIG. 4 is a perspective view of a shaking correction device in according to a second embodiment of the present invention;

FIG. 5 is a perspective view of a shaking correction device in according to a third embodiment of the present invention; and

FIG. 6A and FIG. 6B are perspective views of an existing shaking correction device.

### DETAILED DESCRIPTION OF THE INVENTION

The invention will now be described in detail through several embodiments with reference to the accompanying drawings, and the following embodiments do not limit claims in the present invention, and the combination of all features described in the embodiments does not necessary for solutions of the present invention.

### First Embodiment

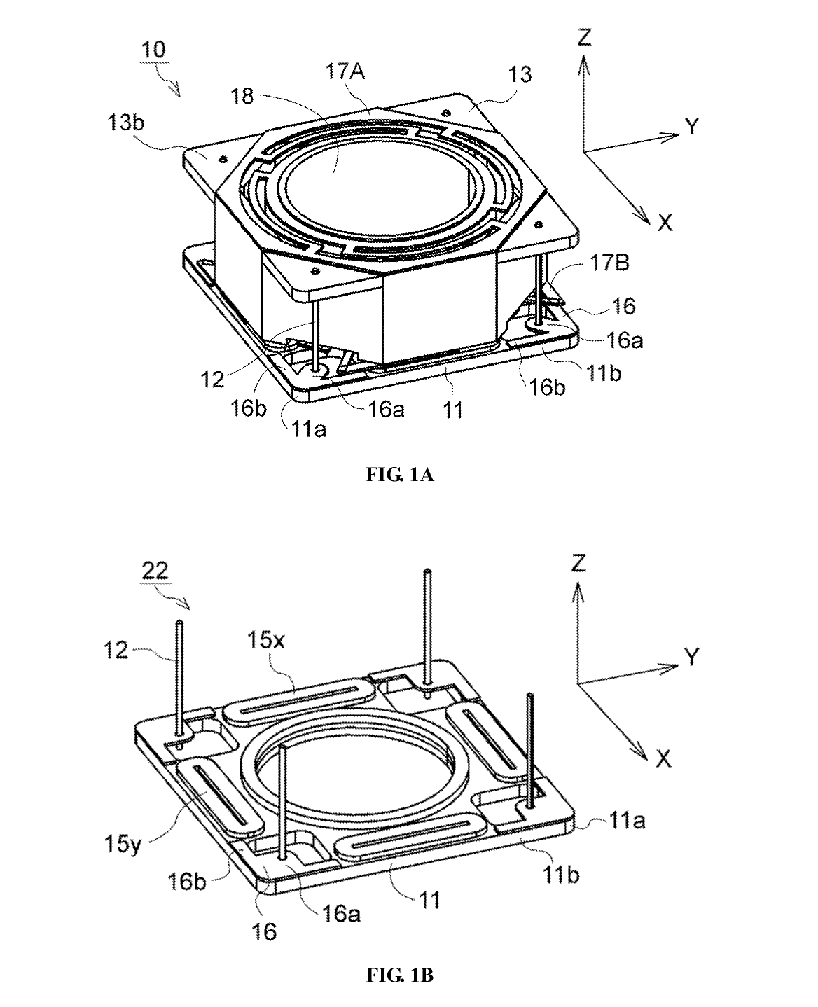

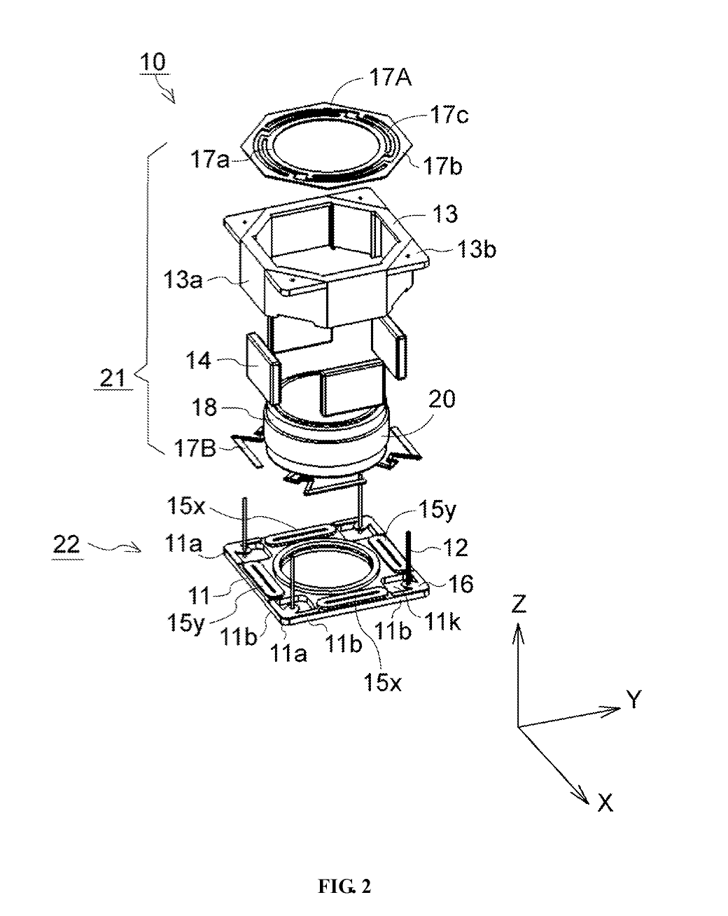

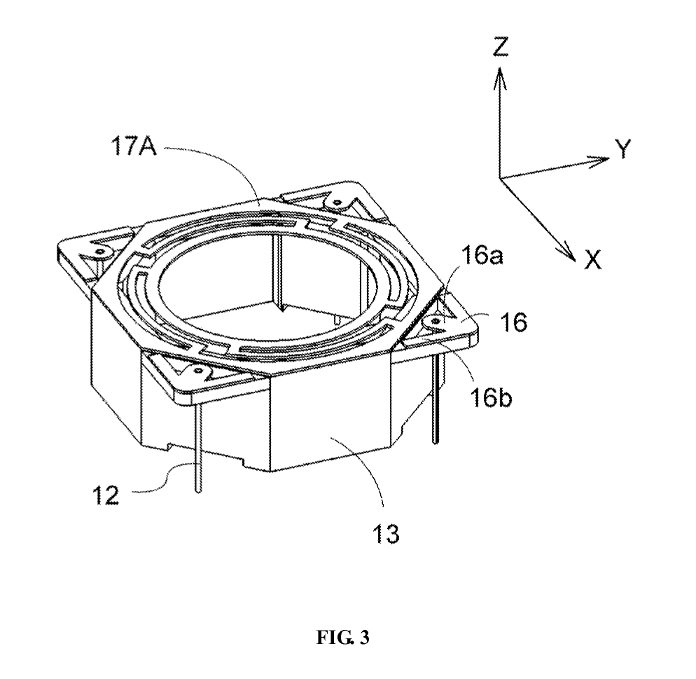

FIG. 1A is a perspective view of a shaking correction device 10 in according to a first embodiment of the present invention, and FIG. 2 is an exploded view of the shaking correction device 10. Below, a direction of an optical axis of an unshown lens is taken as the Z (Z axis) direction, the side of the object to be shot is taken as the front (+Z side) of the Z (Z axis) direction, and two directions forming right angles with the Z axis are respectively taken as the X (X axis) direction and the Y (Y axis) direction.

As shown in FIG. 1A and FIG. 2, the shaking correction device 10 is composed of an automatic focusing unit 21 and a swinging unit 22.

The automatic focusing unit 21 includes: a cylindrical lens support 18 for retaining the unshown lens; a coil 20 for automatic focusing wound on the outer circumference side of the lens support 18; four plate-shaped permanent magnets 14 disposed around an axis parallel to the Z axis at 90-degree intervals, and arranged opposite to the coil 20 for automatic focusing at intervals along the radial direction, and the magnetic pole faces of which are respectively facing to the X direction and the Y direction and being; a frame-shaped magnet support 13, the side faces 13a of which retains the permanent magnets 14; a front side spring component 17A and a back side spring component 17B.

The swinging unit 22 includes: a plate-shaped base plate 11 provided with an opening in the center and faces to the Z direction; four suspension wires 12 extending along the Z direction; the magnet support 13 in the specification involving the automatic focusing unit 21; the permanent magnets 14; X side coils 15x for swinging and Y side coils 15y for swinging which are wound on the Z direction, and are arranged opposite to the −Z side faces of the permanent magnets 14 at intervals and are mounted on the +Z side of the base plate 11; and a plurality of elastic beams 16 as elastic components. Therefore, the magnet support 13 and the permanent magnets 14 in the embodiment are shared by the automatic focusing unit 21 and the swinging unit 22. Moreover, the swinging unit 22 is used for supporting the automatic focusing unit 21 on the +Z side of the base plate 11 in a suspension mode.

Each end part of the lens support 18 of the automatic focusing unit 21 in front of the Z axis direction and at the back of the Z axis direction is respectively connected with the front side spring component 17A and the back side spring component 17B. Specifically, the lens support 18 is respectively connected with the respective inner side retaining parts 17a of the front side spring component 17A and the back side spring component 17B, and the end parts of the magnet support 13 in front of the Z axis direction and at the back of the Z axis direction are respectively connected with the respective outer side retaining parts 17b of the front side spring component 37A and the back side spring component 17B. Moreover, the respective wrist parts 37c of the front side spring component 17A and the back side spring component 17B are taken as springs to take effect so as to support the lens support 18 to be capable of moving in the Z direction in a suspension mode.

The lens support 18 supported by the front side spring component 17A and the back side spring component 17B in a suspension mode is taken as the automatic focusing unit 21 to take effect. Therefore, along with the electrification of the coil 20 for automatic focusing, the lens support 18 can move in the Z axis direction.

Flange parts 13b protruding to the outside in the radial direction are formed at the four corners in front of the Z axis direction of the magnet support 13. The flange parts 13b are formed to be approximately triangle-shaped, and the back sides in the Z axis direction of the flange parts are connected with the other ends of the suspension wires 12.

Square opening parts 11k are formed at the four corners of the base plate 11 of the swinging unit 22. L-shaped base frames 11b are arranged on the two sides of the circumference direction of the four corner parts 11a on the base plate 11. The elastic beams 16 as the elastic components are mounted on the corner parts 11a of the front side of the Z axis direction of the base frames 11b respectively. Each elastic beam 16 includes: an extension end 16a extending from a corner part 11a of the base plate 11 to the center of the automatic focusing unit 21 along the direction orthogonal to the Z axis (X axis direction, Y axis direction); and an L-shaped fixed frame 16b connected with the base frames 11b and extending along the base frames 11b.

One end of each of the four suspension wires 12 is connected with the extension end 16a of the elastic beam 16. The other end of each of the suspension wires 12 is connected with the flange part 13b of the magnet support 13. As a result, the automatic focusing unit 21 is supported by the suspension wires 12 to be capable of swinging in the X direction and the Y direction.

The X side coils 35x for swinging are respectively disposed on the −X side and the +X side of the base plate 11. Moreover, the Y side coils 35y for swinging are respectively disposed on the −Y side and the +Y side of the base plate 11. As a result, along with the electrification of the X side coils 35x for swinging, the permanent magnets 14 (automatic focusing unit 21) swing in the X direction. Along with the electrification of the Y side coils 35y for swinging, the permanent magnets 14 (automatic focusing unit 21) swing in the Y direction. That is to say, the automatic focusing unit 21 is supported by the suspension wires 12 to be capable of swinging in the X direction and the Y direction so as to correct the shaking generated on the lens.

When the shaking correction device 10 enables the automatic focusing unit 21 to swing, the extension ends 16a of the elastic beams 16 are bent in the direction that the automatic focusing unit 21 is difficult to rotate so as to prevent the optical axis of the unshown lens from being tilt. Moreover, even if under the condition that acting force towards the direction (+Z direction) far away from the base plate 11 or acting force towards the direction (−Z direction) close to the base plate 11 is applied to the automatic focusing unit 41 due to falling, the extension ends 16a of the elastic beams 16 can also be elastically bent and deformed in the Z direction so as to reduce the tension or compressing force applied to the suspension wires 12. As a result, the elastic beams 16 can prevent the suspension wires 12 from being broken.

Moreover, FIG. 1B is a perspective view of a variation embodiment of the elastic beam 16 in the swinging unit 22. As shown in the figure, the suspension wires 12 are connected with the inner end side of the elastic beams 16. For example, the shape of the extension end 16a of the elastic beam 16 can be changed into various shapes that the thickness on the outer end side is larger and the thickness on the inner end side is smaller.

Moreover, in the embodiment, the shown elastic beams 16 are divided at each corner part 11a of the base plate 11, but the fixed frames 16b of the four elastic beams 16 can also be extended along the edges of the base plate 11, and a frame-shaped structure that the four elastic beams 16 are connected with each other is formed. Moreover, the elastic beams 16 can also be connected to the back of the Z axis direction of the base plate 11.

Moreover, as shown in the variation embodiment shown in FIG. 3, the elastic beams 16 can also be arranged on the side of the magnet support 13. In the case of the variation embodiment, the structure that the elastic beams 16 and the front side spring component 17A are mutually separated is shown, but the elastic beams 16 and the front side spring component 17 can also be formed into integration. Thus, the elastic beams 16 can also be arranged on both of the base plate 11 and the magnet support 13 respectively.

### Second Embodiment

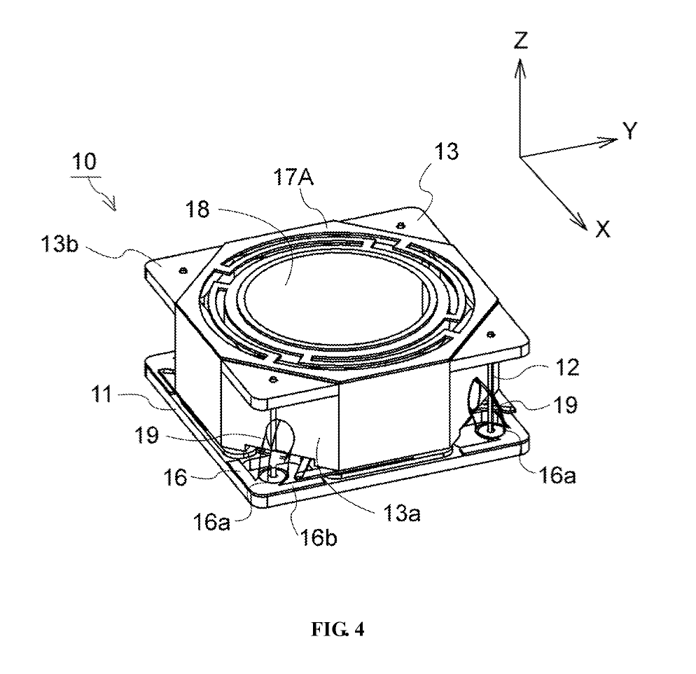

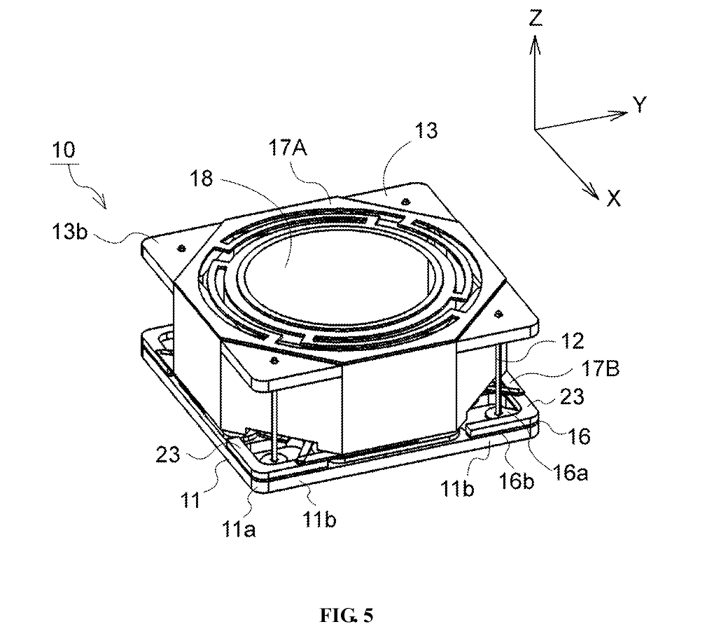

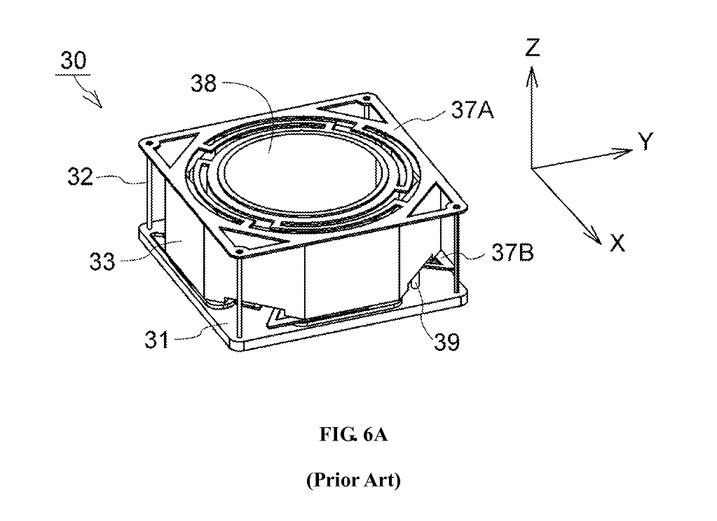

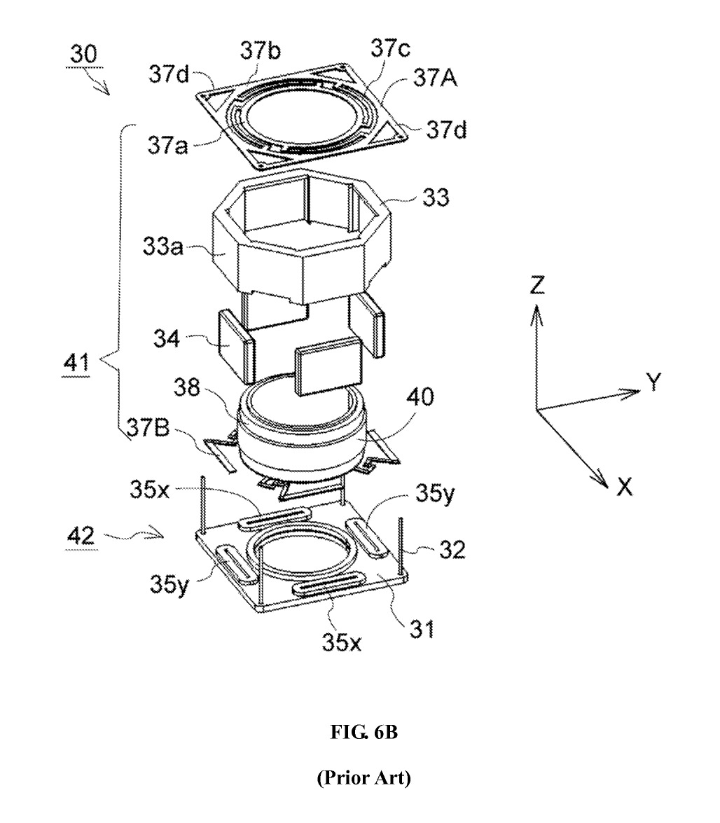

FIG. 4 is a perspective view of an example of the shaking correction device 10 in a second embodiment in the present invention. Besides the structure of the shaking correction device 10 in the first embodiment, the point that the shaking correction device 10 in the second embodiment includes a plurality of buffer components 19 is different from the shaking correction device 10 in the first embodiment. Moreover, with reference to the first embodiment, the same component is referenced by identical reference numbers, and the description is omitted. Moreover, in the figure, to make better visibility of the hidden components, such as the parts of the suspension wires 12, those are covered by the buffer components 19, components 19 is transparently shown.

The shaking correction device in the second embodiment is the same as that in the first embodiment, and is composed of an automatic focusing unit 21 and a swinging unit 22.

The automatic focusing unit 21 includes a lens support 18, a coil 20 for automatic focusing, four permanent magnets 14, a magnet support 13, a front side spring component 17A and a back side spring component 17B.

The swinging unit 22 includes a base plate 11, suspension wires 12, a magnet support 13, permanent magnets 14, X side coils 15x for swinging, Y side coils 15y for swinging and an elastic beam 16. The automatic focusing unit 21 is supported on the +Z side of the base plate 11 in a suspension mode. The magnet support 13 and the permanent magnets 14 are shared by the automatic focusing unit 21 and the swinging unit 22.

The buffer components 19 are formed by resin such as silicone gel, and are disposed in the state of being arranged among the elastic beams 16, the suspension wires 12 and the side faces 13a of the magnet support 13. In more detail, one side of each buffer components 19 is arranged to wrap/cover a corresponding extension end 16a of an elastic beam and a (lower) part of a corresponding suspension wire 12, and the other side of the buffer component 19 is arranged on a corresponding one of the side faces 13a of the magnet support 13.

Therefore, the unnecessary vibration of the extension ends 16a, the unnecessary vibration of the suspension wires 12 and the unnecessary resonance of the whole shaking correction device 10 can be restrained respectively, even if the shaking correction device 10 suffers from impact, the elastic deformation of the extension ends 16a of the elastic beams 16 can also be utilized for preventing the suspension wires 12 form being broken.

Moreover, the setting positions of the buffer components 19 are located near the side faces 13a of the magnet support 13, namely outside the shaking correction device 10, and thus the buffer components 19 can be easier to mount and coat, and the assembling work efficiency is improved.

### Third Embodiment

FIG. 5 is a perspective view of the shaking correction device 10 in a third embodiment. Besides the structure of the shaking correction device 10 in the first embodiment, the point that the shaking correction device 10 in the third embodiment includes a plurality of reinforcement frames 23 is different from the shaking correction device 10 in the first embodiment. Moreover, with reference to the first embodiment, the same component is referenced by identical numbers, and the description is omitted.

The shaking correction device 10 in the embodiment is the same as that in each of the embodiment, and is composed of an automatic focusing unit 21 and an swinging unit 22.

The automatic focusing unit 21 includes a lens support 18, a coil 20 for automatic focusing, four permanent magnets 14, a magnet support 13, a front side spring component 17A and a back side spring component 17B.

The swinging unit 22 includes a base plate 11, a plurality of suspension wires 12, a magnet support 13, a plurality of permanent magnets 14, X side coils 15x for swinging, Y side coils 15y for swinging, a plurality of elastic beams 16, and the reinforcement frames 23. The automatic focusing unit 21 is supported on the +Z side of the base plate 11 in a suspension mode by the swinging unit 22. The magnet support 13 and the permanent magnets 14 are shared by the automatic focusing unit 21 and the swinging unit 22.

The reinforcement frames 23 are L-shaped components arranged along the fixed frames 16b of the elastic beams 16, and are mounted in front of the Z axis direction of the fixed frames 16b of the elastic beams 16. Moreover, the elastic beams 16 are fixed in the state of being clamped by the reinforcement frames 23 and the base frames 11b. Thus, the elastic beams 16 can be firmly fixed, and thus even if the elastic beams 16 are impacted, the elastic beams 16 cannot fall off from the base plate 11 and the extension ends 16a can absorb the impact force stably.

Moreover, the elastic beams 16 are connected to the back of the Z axis direction of the base plate 11, and the reinforcement frames 23 are mounted at the back of the elastic beams 16, so that the fixed frames 16b of the elastic beams 16 can be clamped. Moreover, in the variation embodiment of the shaking correction device 10 as shown in FIG. 3, under the condition that the elastic beams 16 are arranged on the magnet support 13, the reinforcement frames 23 are mounted on the magnet support 13, and thus the elastic beams 16 can be clamped just by utilizing the reinforcement frames 23 and the magnet support 13.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A shaking correction device, comprising:
an automatic focusing unit configured for retaining a lens and enabling the lens to move in the Z axis direction, a side of an object to be shot being taking as a front of an Z axis direction; and
a swinging unit configured for enabling the automatic focusing unit to swing in a direction forming a right angle with the Z axis direction;
wherein the swinging unit comprises:
a base plate arranged at the back of the automatic focusing unit in the Z axis direction;
a magnet support disposed on an outer circumference of the automatic focusing unit;
a plurality of suspension wires extending from the base plate toward the front of the Z axis direction and configured for supporting the magnet support in a suspension mode; and
a plurality of elastic beams, each of which comprising an extension end extending towards the automatic focusing unit and capable of being bent towards the Z axis direction;
wherein the plurality of elastic beams is mounted on one or both of the base plate and the magnet support, and one or both ends of each of the plurality of suspension wires are connected with corresponding extension ends of the plurality of elastic beams.

2. The shaking correction device according to claim 1, wherein further comprises a plurality of buffer components configured for restricting vibrations of the shaking correction device; the plurality of buffer components are bridged between the plurality of elastic beams, the plurality of suspension wires and the side faces of the magnet support.

3. The shaking correction device according to claim 2, wherein a plurality of reinforcement frames configured for fixing the plurality of elastic beams onto one or both of the base plate and the magnet support are mounted on the elastic beams.

4. The shaking correction device according to claim 3, wherein the plurality of reinforcement frames does not cover the extension ends of the plurality of elastic beams.

5. The shaking correction device according to claim 1, wherein a plurality of reinforcement frames configured for fixing the plurality of elastic beams onto one or both of the base plate and the magnet support are mounted on the elastic beams.

6. The shaking correction device according to claim 5, wherein the plurality of reinforcement frames does not cover the extension ends of the plurality of elastic beams.
